(19) United States
(12) Patent Application Publication
(10) Pub. No.: US 2006/0058458 A1
(43) Pub. Date: Mar. 16, 2006

(54) Coating agents for producing rigid coatings resistant to scratching and soiling and rigid moulded bodies resistant to scratching and soiling and method for the production thereof

(75) Inventors: Thomas Hasskerl, Kronberg (DE); Patrick Becker, Muehtal (DE); Rolf Neeb, Pfungstadt (DE); Ghirmay Seyoum, Egelsbach (DE); Reiner Lingelbach, Heinrich-von-Kleist-Strasse (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Roehm Gmbh & Co. KG, Darmstadt (DE)

(21) Appl. No.: 10/539,126

(22) PCT Filed: Oct. 18, 2003
(86) PCT No.: PCT/EP03/11546

§ 371 Date: Jun. 16, 2005

(30) Foreign Application Priority Data
Dec. 19, 2002 (DE) 10260067.8

(51) Int. Cl. C08G 63/60

(52) U.S. Cl. 524/599

(57) ABSTRACT

The invention relates to coating agents for producing rigid coatings resistant to scratching and soiling which contain: A) 1-30 mass % polymer produced by free radical polymerisation of a mixture containing A1) 1-10 weight parts of at least one sulphur compound containing at least 3 thiol groups and A2) 90-99 weight parts of alkylmethacrylate; B) 0.2-10% mass of at least one fluoralkyl(meth)acrylate having from 3 to 30 carbon atoms in an alcohol radical which comprises from 6 to 61 fluorine atoms; C) 20-80 mass % multifunctional (methyl)acrylate; D) 0.01-10 mass % of at least one initiator; E) 5-75 mass % of at least one solvent and F) 0-40 mass % ordinary additives. The rigid moulded bodies resistant to scratching and soiling and comprising a plastic substrate and scratching resistant coating are also disclosed.

The present invention relates to coating compositions for producing formable scratchproof coatings with dirt repellency effect, to mouldings coated with these coating compositions, having a scratchproof, formable and dirt-repellent coating, and to processes for producing the coated mouldings.

Thermoplastically deformable polymers by their nature do not match the scratch resistance of many metals or mineral glasses. The susceptibility to scratches is manifested to particular disadvantage in transparent polymers, since the articles in question very quickly lose their aesthetic quality.

Scratchproof coatings for polymers are known per se. By way of example document DE 195 07 174 describes UV-curing scratchproof coatings for polymers, which exhibit a particularly high UV stability. These coatings already show a good spectrum of properties. However, polymeric mouldings, including those with scratchproof coatings, are used primarily in the form of panels in outdoor construction, such as in sound-proof walls or as glazing for facades, bus shelters, advertising spaces, advertising pillars, street furniture, where they are subject both to natural soiling and to defilement caused by vandalism, such as graffiti daubings, for example. Cleaning such surfaces is very costly and inconvenient, since in many cases the surface is attacked as a result.

In order to solve these problems it is common to add fluorine-containing acrylates to the coating compositions. Coating compositions of this kind are described, for example, in DE 43 19 199.

A disadvantage of known coating compositions, however, is that the coatings produced from them form cracks on polymeric articles in the course of heat forming, the coating on the formed article taking on a milky cloudiness and losing its aesthetic quality.

Subsequent forming of the panels, provided with a hydrophobic and oleophobic coat, however, is desirable for a variety of reasons. For instance, in particular, the transport costs for planar panels are lower than those of formed articles, owing to the improved stackability.

A further factor to consider is that the production of coated panels and their use, for example as a construction component, is carried out by different companies. Accordingly, coated formable construction components can be manufactured for much wider consumer circles than preformed panels produced specifically for one customer.

Furthermore, many particularly advantageous coating techniques, such as roller techniques, for example, are difficult if not impossible to perform on formed components.

In the light of the prior art discussed and indicated herein it was therefore an object of the present invention to specify coating compositions which can be used to produce formable scratchproof coatings with a dirt repellency effect.

It was thus also an object of the present invention to provide coating compositions for producing scratchproof coatings which exhibit particularly high adhesion to polymeric substrates. This property ought not to be impaired by heat forming.

A further object of the invention was that polymeric articles having a scratchproof coating according to the invention should have a high durability, in particular a high resistance to UV irradiation or weathering.

A further objective of the present invention was to provide coating compositions having an anti-graffiti effect which do not adversely alter the properties of the substrate.

Accordingly, the spray paints used to produce graffiti should as a result of an anti-graffiti treatment in the course of the invention no longer adhere, or should adhere only very weakly, to the polymeric article, with sprayed substrates being easy to clean, so that, for example, water, cloths, surfactant, pressure washes and mild solvents are sufficient.

A further object of the invention was to provide scratchproof dirt-repellent mouldings which are particularly easy to produce. Accordingly, for producing the mouldings, it ought to be possible in particular to use substrates which are obtainable by extrusion, injection moulding and by casting techniques.

Another object of the present invention was to specify scratchproof formable dirt-repellent mouldings which exhibit outstanding mechanical properties. This property is particularly important for applications where the polymeric articles are to have a high stability to impact.

Furthermore, the mouldings ought to have particularly good optical properties.

Another objective of the present invention was to provide scratchproof formable dirt-repellent mouldings which can be adapted simply and largely to the requirements.

The achievement of these objects and of others which, although not referred to explicitly, can nevertheless be derived as self-evident from the circumstances discussed herein or result automatically from the said circumstances, is provided by the coating compositions described in claim 1. Judicious modifications of the coating compositions of the invention are protected in the dependent claims appendant to claim 1.

As far as the mouldings are concerned claims 12-21 offer means of achieving the objects on which they are based.

By virtue of the fact that a coating composition comprises
A) from 1 to 30% by weight of a prepolymer obtainable by free-radically polymerizing a mixture comprising
   A1) from 1 to 10 parts by weight of at least one sulphur compound containing at least 3 thiol groups and
   A2) from 90 to 99 parts by weight of alkyl (meth)acrylates,
B) from 0.2 to 10% by weight of at least one fluoroalkyl (meth)acrylate having 3 to 30 carbon atoms in the alcohol residue and including 6 to 61 fluorine atoms,
C) from 20 to 80% by weight of polyfunctional (meth)acrylates,
D) from 0.01 to 10% by weight of at least one initiator,
E) from 2 to 75% by weight of at least one diluent and
F) from 0 to 40% by weight of customary additives
   it is possible to provide surprisingly scratch-proof dirt-repellent mouldings which can be heat formed without any cloudiness occurring.

As a result of the measures according to the invention the following advantages in particular, among others, are obtained:
The scratchproof coatings obtained with the coating compositions of the invention exhibit particularly high adhesion to the polymeric substrates, and this property is not impaired even by weathering.
The coated mouldings exhibit high resistance to UV irradiation.
The coating compositions of the invention and coated mouldings obtainable from them can be produced inexpensively.
Furthermore, polymeric articles coated in accordance with the invention show a particularly low surface energy. As a result, the present mouldings are particularly easy to clean.
Scratchproof mouldings of the present invention can be adapted easily to particular requirements. In particular the size and shape of the polymeric article can be varied within wide ranges without thereby adversely affecting its formability. Moreover, the present invention also provides mouldings having outstanding optical properties.
The scratchproof formable dirt-repellent mouldings of the present invention have good mechanical properties.
   Component A

The coating compositions of the invention for producing formable scratchproof coatings with dirt repellency effect contain 1-30% by weight, preferably 2-25% by weight, based on the weight of the coating composition, of a prepolymer obtainable by free-radically polymerizing a mixture comprising
A1) 1-10 parts by weight, preferably 2-6 parts by weight of at least one sulphur compound containing at least three thiol groups and
A2) 90-99 parts by weight, preferably 94-98 parts by weight of alkyl (meth)acrylates.

Sulphur compounds having more than two thiol groups in the molecule are known for example from U.S. Pat. No. 4,521,567. The invention is performed using sulphur compounds having at least three, preferably four thiol groups in the molecule. The sulphur regulators contain preferably at least 3, more preferably at least 6 carbon atoms in the molecule, but not more than 40. The presence of one or, preferably, more α-mercaptocarboxylic ester groups in the molecule is advantageous, preferably starting from polyols, such as glycerol or pentaerythritol. Examples of suitable sulphur regulators having more than three thiol groups include 1,2,6-hexanetriol trithioglycolate, trimethylolethane trithioglycolate, pentaerythritol tetrakis(2-mercaptoacetate), trimethylolethane tri(3-mercaptopropionate), pentaerythritol tetrakis(3-mercaptopropionate), trimethylolpropane trithioglycolate, trimethylolpropane tri(3-mercaptopropionate), tetrakis(3-mercaptopropionato)pentaerythritol, 1,1,1-propanetriyl tris(mercaptoacetate), 1,1,1-propanetriyl tris(3-mercaptopropionate), dipentaerythritol hexa(3-mercaptopropionate). Particularly suitable is pentaerythritol tetrakis(2-mercaptoacetate) (pentaerythritol tetrathioglycolate).

The acrylic (meth)acrylates which can be used in accordance with the invention to prepare the prepolymer are known per se, the expression (meth)acrylate standing for acrylates, methacrylates and for mixtures of both. The alkyl (meth)acrylates have preferably 1-20, in particular 1-8 carbon atoms.

Examples of the C₁ to C₈ alkyl esters of acrylic acid and of methacrylic acid are methyl acrylate, ethyl acrylate, propyl acrylate, isopropyl acrylate, n-butyl acrylate, isobutyl acrylate, n-hexyl acrylate and 2-ethylhexyl acrylate, methyl methacrylate, ethyl methacrylate, n-propyl methacrylate and butyl meth-acrylate. Preferred monomers are methyl methacrylate and n-butyl acrylate.

The prepolymer is prepared using preferably mixtures of alkyl (meth)acrylates containing at least 10% by weight of methyl (meth)acrylate and/or ethyl acrylate and at least 2% by weight of alkyl (meth)acrylates having 3-8 carbon atoms. Preference is given, for example, to methyl methacrylate fractions of 50-99% by weight, butyl methacrylate fractions of from 5 to 40% by weight and acrylate fractions of from 2 to 50% by weight.

In the preparation of the thickening polymers it is possible to vary the proportions of regulator to monomers.

The polymerization of regulators and monomers can be conducted in conventional manner as a bulk, suspension or bead, solution or emulsion polymerization with the aid of free-radical initiators. A suitable process for bead polymerization can be taken or derived from DE 33 29 765 C2/U.S. Pat. No. 4,521,567, for example (polymerization step stage A).

Suitable free-radical initiators include for example peroxide compounds or azo compounds (U.S. Pat. No. 2,471,959). Examples that may be mentioned include organic peroxides such as dibenzoyl peroxide, lauryl peroxide or per esters such as tert-butyl per-2-ethylhexanoate, and azo compounds such as azobisisobutyronitrile.

The thickener polymers obtained can have molecular weights of about 2000 to 50,000, depending on polymerization process and regulator fraction. The molecular weight may be determined in particular by viscosimetry, with the prepolymer A) preferably having a viscosity number to DIN ISO 1628-6 in the range from 8 to 15 ml/g, in particular from 9 to 13 ml/g and with particular preference from 10 to 12 ml/g, measured in CHCl₃ at 20° C.

Component B

The coating compositions of the present invention include as essential constituent 0.2-10% by weight, preferably 0.3-5.0% by weight and very preferably 0.5-2% by weight, based on the total weight of the coating composition, of fluoroalkyl (meth)acrylates having 3-30, preferably 8 to 25 and more preferably 10 to 20 carbon atoms in the alcohol residue and including 6-61, preferably 7 to 51 and more preferably 9 to 41 fluorine atoms. In addition to the fluorine atoms the alcohol residue of the fluoroalkyl (meth)acrylate may include further substituents. These include, in particular, ester groups, amide groups, amine groups, nitro groups and halogen atoms, and this alcohol residue can be either linear or branched.

In accordance with one particular aspect of the present invention a fluoroalkyl (meth)acrylate of the formula I is used 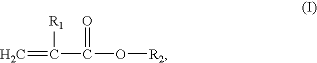
in which the radical R₁ is a hydrogen atom or a methyl group and the radical R₂ is a fluorinated alkyl radical of the formula CₐH_{b}F_{c} in which a is an integer in the range from 3 to 30, in particular from 8 to 25 and more preferably from 10 to 20, b is an integer in the range from 0 to 4 and c is an integer in the range from 6 to 61, preferably from 9 to 41, where c=2a+1−b.

In accordance with one particularly preferred aspect of the present invention a fluoroalkyl (meth)acrylate of the formula II is used 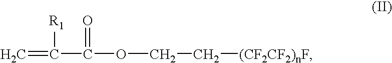
in which the radical R₁ is a hydrogen atom or a methyl radical and n is an integer in the range from 2 to 10, preferably from 3 to 8, more preferably from 3 to 5.

The fluoroalkyl (meth)acrylates present in the coating compositions of the invention in accordance with component B) include 2,2,3,4,4,4-hexafluorobutyl acrylate, 2,2,3,4,4,4-hexafluorobutyl methacrylate, nonadecafluoroisodecyl methacrylate, 2,2,3,3,4,4,4-heptafluorobutyl acrylate, 3,3,4,4,5,5,6,6,6-nonafluorohexyl acrylate, 3,3,4,4,5,5,6,6,6-nonafluorohexyl methacrylate, 2,2,3,3,4,4,5,5,6,6,7,7,7-tridecaflurorheptyl acrylate, 3,3,4,4,5,5,6,6,7,7,8,8,8-tridecafluorooctyl acrylate, 3,3,4,4,5,5,6,6,7,7,8,8,8-tridecafluorooctyl methacrylate, 2,2,3,3,4,4,5,5,6,6,7,7,8,8,9,9,9-heptadecafluorononyl acrylate, 3,3,4,4,5,5,6,6,7,7,8,8,9,9,10,10,10-heptadecafluorodecyl acrylate, 2,2,3,3,4,4,5,5,6,6,7,7,8,8,9,9,10,10,11,11,11-eicosafluoroundecyl acrylate, 3,3,4,4,5,5,6,6,7,7,8,8,9,9,10,10,11,11,12,12-eicosafluorododecyl acrylate, 3,3,4,4,5,5,6,6,7,7,8,8,9,9,10,10,11,11,12,12,12-hen-eicosafluorododecyl acrylate, 3,3,4,4,5,5,6,6,7,7,8,8,9,9,10,10,11,11,12,12,12-hen-eicosafluorododecyl methacrylate, 4,4,5,5,6,6,7,7,8,8,9,9,10,10,11,11,12,12,13,13,14,15,15,15-tetracosafluoro-2-hydroxy-4(trifluoromethyl)-pentadecyl acrylate, 3,3,4,4,5,5,6,6,7,7,8,8,9,9,10,10,11,11,12,12,13,13,14,14,14-pentacosafluorotetradecyl acrylate, 3,3,4,4,5,5,6,6,7,7,8,8,9,9,10,10,11,11,12,12,13,13,14,14,14-pentacosafluorotetradecyl methacrylate, 3,3,4,4,5,5,6,6,7,7,8,8,9,9,10,10,11,11,12,12,13,13,14,14,15,15,16,16,16-nonacosafluorohexadecyl acrylate, 3,3,4,4,5,5,6,6,7,7,8,8,9,9,10,10,11,11,12,12,13,13,14,14,15,15,16,16,16-nonacosafluorohexadecyl methacrylate, 3,3,4,4,5,5,6,6,7,7,8,8,9,9,10,10,11,11,12,12,13,13,14,14,15,15,16,16,17,17,18,18,19,19,20,20,20-heptatriacontafluoroeicosyl acrylate.

The fluoroalkyl (meth)acrylates are known compounds, and can be used individually or as a mixture.

Component C

To produce a scratchproof coating, in accordance with the invention crosslinking monomers are added to the coating composition. These possess at least two polymerizable units, e.g. vinyl groups, per molecule (cf. Brandrup-Immergut Polymer Handbook). They are used in accordance with the invention in amounts of 20-80% by weight, preferably 50-70% by weight, based on the total weight of the coating composition.

Mention may be made of the diesters and higher esters of acrylic and methacrylic acid with polyhydric alcohols such as glycol, glycerol, trimethylolethane, trimethylolpropane, pentaerythritol, diglycerol, dimethylolpropane, ditrimethylolethane, dipentaerythritol, trimethylhexane-1,6-diol and cyclohexane-1,4-diol.

Examples of crosslinking monomers of this kind include ethylene glycol diacrylate, ethylene glycol dimethacrylate, propylene glycol diacrylate, propylene glycol dimethacrylate, 1,3-butanediol diacrylate, 1,3-butanediol dimethacrylate, neopentylglycol diacrylate, neopentylglycol dimethacrylate, diethylene glycol diacrylate, diethylene glycol dimethacrylate, 4-thioheptanol 2,6-diacrylate, 4-thioheptanol 2,6-dimethacrylate, tetraethylene glycol diacrylate, tetraethylene glycol dimethacrylate, pentanediol diacrylate, pentanediol dimethacrylate, hexanediol diacrylate, hexanediol dimethacrylate, trimethylolpropane tri-(meth)acrylate, dimethylolpropane tetraacrylate, ditrimethylolpropane tetramethacrylate, dipentaerythritol hexaacrylate and dipentaerythritol hexamethacrylate, pentaerythritol triacrylate and pentaerythritol tetraacrylate.

The polyfunctional acrylates and methacrylates can also be oligomers or polymers, which may also include further functional groups. Mention may be made in particular of urethane diacrylates and triacrylates or corresponding ester acrylates.

Component D

The coating composition of the invention is polymerized or cured using known initiators which are added to the coating composition in an amount of 0.01-10% by weight, preferably 1-3% by weight, based on the total weight of the coating composition.

The preferred initiators include those azoinitiators which are widely known in the art, such as AIBN and 1,1-azobiscyclohexanecarbonitrile, and also peroxy compounds, such as methyl ethyl ketone peroxide, acetylacetone peroxide, dilauryl peroxide, tert-butyl per-2-ethylhexanoate, ketone peroxide, methyl isobutyl ketone peroxide, cyclohexanone peroxide, dibenzoyl peroxide, tert-butyl peroxybenzoate, tert-butyl peroxyisopropyl carbonate, 2,5-bis(2-ethylhexanoylperoxy)-2,5-dimethylhexane, tert-butyl peroxy-2-ethylhexanoate, tert-butyl peroxy-3,5,5-trimethylhexanoate, dicumyl peroxide, 1,1-bis (tert-butylperoxy) cyclohexane, 1,1-bis(tert-butylperoxy)-3,3,5-trimethylcyclohexane, cumyl hydroperoxide, tert-butylhydroperoxide, bis-(4-tert-butylcyclohexyl) peroxydicarbonate, mixtures of two or more of the aforementioned compounds with one another and also mixtures of the aforementioned compounds with compounds not specified which are likewise able to form free radicals.

In accordance with one particular aspect of the present invention curing is carried out using photoinitiators, such as UV initiators, for example. These are compounds which give off free radicals under irradiation by visible or UV light and so initiate the polymerization of the coating composition. Customary UV initiators in accordance with DE-A 29 28 512, for example, are benzoin, 2-methylbenzoin, benzoin methyl, ethyl or butyl ether, acetoin, benzil, benzil dimethyl ketal or benzophenone. UV initiators of this kind are available commercially, for example, from Ciba AG under the trade names ®Darocur 1116, ®Irgacure 184, ®Irgacure 907 and from BASF AG under the brand name ®Lucirin TPO.

Examples of photoinitiators which absorb within the short wave visible region of light are ®Lucirin TPO and ®Lucirin TPO-L from BASF, Ludwigshafen.

Component E

As diluents it is possible to use both organic solvents and/or monofunctional reactive diluents. In general the coating compositions contain from 2 to 75%, preferably from 6 to 50% by weight, based on the total weight of the coating composition, of diluents, which can also be used as a mixture.

With the aid of the diluents it is possible to set a coating composition viscosity in the range from about 10 to about 250 mPa·s. For coating compositions which are intended for flow coating or dip coating operations it is more customary to use low viscosities of about 1-20 mPa·s. In these coating materials it is possible in particular to use organic solvents in concentrations of up to 75% by weight. For knife coating or roller application coating purposes the appropriate viscosities are situated within the range from 20 to 250 mPa·s. The values stated are to be regarded merely as guideline values and refer to the measurement of the viscosity at 20° C. with a rotational viscometer in accordance with DIN 53 019.

In the case of coating materials for roller application processes it is preferred to use monofunctional reactive diluents. Customary concentrations are between 5 and 25% by weight. Alternatively or in combination, however, it is also possible to use organic solvents as diluents.

The monofunctional reactive diluents contribute to good levelling properties of the coating material and hence to good processing properties. The monofunctional reactive diluents possess a free-radically polymerizable group, generally a vinyl function.

These include, inter alia, 1-alkenes, such as hex-1-ene, hept-1-ene; branched alkenes, such as vinylcyclohexane, 3,3-dimethyl-1-propene, 3-methyl-1-diisobutylene, 4-methylpent-1-ene, for example;
acrylonitrile; vinyl esters, such as vinyl acetate; styrene, substituted styrenes having an alkyl substituent in the side chain, such as α-methylstyrene and α-ethylstyrene, for example, substituted styrenes having an alkyl substituent on the ring, such as vinyltoluene and p-methylstyrene, halogenated styrenes, such as monochlorostyrenes, dichlorostyrenes, tribromostyrenes and tetrabromostyrenes, for example;
heterocyclic vinyl compounds, such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles, vinyloxazoles and hydrogenated vinyloxazoles;
vinyl and isoprenyl ethers;
maleic acid derivatives, such as maleic anhydride, methylmaleic anhydride, maleimide and methylmaleimide, for example;
and (meth)acrylates, with (meth)acrylates being particularly preferred. The expression (meth)acrylates embraces methacrylates and acrylates and also mixtures of both.

These monomers are widely known. They include (meth)acrylates derived from saturated alcohols, such as methyl (meth)acrylate, ethyl (meth)acrylate, propyl (meth)acrylate, n-butyl (meth)acrylate, tert-butyl (meth)acrylate, pentyl (meth)acrylate and 2-ethylhexyl (meth)acrylate, for example;
(meth)acrylates derived from unsaturated alcohols, such as oleyl (meth)acrylate, 2-propynyl (meth)acrylate, allyl (meth)acrylate, vinyl (meth)acrylate, for example;
aryl (meth)acrylates, such as benzyl (meth)acrylate or phenyl (meth)acrylate, it being possible for each of the aryl radicals to be unsubstituted or to be substituted up to four times;
cycloalkyl (meth)acrylates, such as 3-vinylcyclohexyl (meth)acrylate, bornyl (meth)acrylate;
hydroxyalkyl (meth)acrylates, such as
3-hydroxypropyl (meth)acrylate,
3,4-dihydroxybutyl (meth)acrylate,
2-hydroxyethyl (meth)acrylate,
2-hydroxypropyl (meth)acrylate;
glycol di(meth)acrylates, such as 1,4-butanediol di(meth)acrylate,
(meth)acrylates of ether alcohols, such as tetrahydrofurfuryl (meth)acrylate, vinyloxyethoxyethyl (meth)acrylate;
amides and nitriles of (meth)acrylic acid, such as
N-(3-dimethylaminopropyl)(meth)acrylamide,
N-(diethylphosphono)(meth)acrylamide,
1-methacryloylamido-2-methyl-2-propanol;
sulphur-containing methacrylates, such as
ethylsulphinylethyl (meth)acrylate,
4-thiocyanatobutyl (meth)acrylate,
ethylsulphonylethyl (meth)acrylate,
thiocyanatomethyl (meth)acrylate,
methylsulphinylmethyl (meth)acrylate and
bis((meth)acryloyloxyethyl) sulphide.

Examples of particularly preferred monofunctional reactive diluents are butyl acrylate, 2-hydroxyethyl acrylate, 2-hydroxyethyl methacrylate, hydroxypropyl acrylate, hydroxypropyl methacrylate, 2-ethoxyethyl methacrylate or 2,2,3,3-tetrafluoropropyl methacrylate, methyl methacrylate, tert-butyl methacrylate, isobornyl methacrylate.

EP 0 035 272 describes customary organic solvents for coating compositions for scratchproof coating materials, which can be used as diluents. Suitable, for example, are alcohols such as ethanol, isopropanol, n-propanol, isobutyl alcohol and n-butyl alcohol, methoxypropanol, methoxyethanol. Aromatic solvents as well, such as benzene, toluene or xylene, for example, can be used. Ketones such as acetone or methyl ethyl ketone, for example, are suitable. It is also possible to use ether compounds such as diethyl ether or ester compounds such as ethyl acetate, n-butyl acetate or ethyl propionate, for example. The compounds can be used alone or in combination.

Component F

By customary additives are meant additions customary for coating compositions for scratchproof coatings, which may be present optionally in amounts of 0-40% by weight, in particular from 0 to 20% by weight. The use of these additives is regarded as being not critical for the invention.

Mention may be made here, for example, of surface-active substances, by means of which it is possible to regulate the surface tension of the coating formulation and to achieve good application properties. For this purpose it is possible to make use in accordance with EP 0 035 272, for example, of silicones, such as various polymethylsiloxane types, in concentrations of from 0.0001 to 2% by weight.

Another very common additive are UV absorbers, which may be present in concentrations of, for example, from 0.2 to 20% by weight, preferably from 2 to 8% by weight. UV absorbers can be selected, for example, from the group consisting of hydroxybenzotriazoles, triazines and hydroxybenzophenones (see e.g. EP 247 480).

The coating composition of the invention is intended for producing scratchproof weathering-resistant coatings on polymeric substrates. These include, in particular, polycarbonates, polystyrenes, polyesters, such as polyethylene terephthalate (PET), which may also have been modified with glycol, and polybutylene terephthalate (PBT), cycloolefinic copolymers (COCs), acrylic nitrides/butadiene/styrene [sic] copolymers and/or poly(meth)acrylates.

Preference is given here to polycarbonates, cycloolefinic polymers and poly(meth)acrylates, with poly(meth)acrylates being particularly preferred.

Polycarbonates are known in the art. Polycarbonates can be considered formally as being polyesters of carbonic acid and aliphatic or aromatic dihydroxy compounds. They are easily accessible through reaction of diglycols or bisphenols with phosgene and/or carbonic diesters in polycondensation or transesterification reactions.

Preference is given here to polycarbonates derived from bisphenols. These bisphenols include in particular 2,2-bis(4-hydroxyphenyl)propane (bisphenol A), 2,2-bis-(4-hydroxyphenyl)butane (bisphenol B), 1,1-bis(4-hydroxyphenyl)cyclohexane (bisphenol C), 2,2′-methylenediphenol (bisphenol F), 2,2-bis(3,5-dibromo-4-hydroxyphenyl)-propane (tetrabromobisphenol A) and 2,2-bis(3,5-di-methyl-4-hydroxyphenyl)propane (tetramethylbisphenol A).

Normally aromatic polycarbonates of this kind are prepared by interfacial polycondensation or transesterification, with details being present in Encycl. Polym. Sci. Engng. 11, 648-718.

In interfacial polycondensation the bisphenols are emulsified as an aqueous alkaline solution in inert organic solvents, such as methylene chloride, chlorobenzene or tetrahydrofuran, for example, and are reacted in a staged reaction with phosgene.

Amines are employed as catalysts, and phase transfer catalysts as well are employed in the case of sterically hindered bisphenols. The resulting polymers are soluble in the organic solvents used.

Through the choice of bisphenols it is possible to vary the properties of the polymers widely. Where different bisphenols are used simultaneously it is also possible to construct block polymers in multistage polycondensations.

Cycloolefinic polymers are polymers obtainable using cyclic olefins, especially polycyclic olefins.

Cyclic olefins include, for example, monocyclic olefins, such as cyclopentene, cyclopentadiene, cyclohexene, cycloheptene and cyclooctene, and also alkyl derivatives of these monocyclic olefins having 1 to 3 carbon atoms, such as methyl, ethyl or propyl, such as methylcyclohexene or dimethylcyclohexene, for example, and also acrylate and/or methacrylate derivatives of these monocyclic compounds. In addition it is also possible to use cycloalkanes having olefinic side chains as cyclic olefins, such as cyclopentyl meth-acrylate, for example.

Preference is given to bridged polycyclic olefin compounds. These polycyclic olefin compounds can contain the double bond either in the ring, in which case they are bridged polycyclic cycloalkenes, or in side chains. In this case the compounds in question are vinyl derivatives, allyloxycarboxy derivatives and (meth)acryloyloxy derivatives of polycyclic cycloalkane compounds. These compounds may additionally have alkyl, aryl or aralkyl substituents.

Exemplary polycyclic compounds, without any restriction being intended, include bicyclo[2.2.1]hept-2-ene (norbornene), bicyclo[2.2.1]hept-2,5-diene (2,5-norbornadiene), ethylbicyclo[2.2.1]hept-2-ene (ethylnorbornene), ethylidenebicyclo[2.2.1]hept-2-ene (ethylidene-2-norbornene), phenylbicyclo[2.2.1]hept-2-ene, bicyclo[4.3.0]nona-3,8-diene, tricyclo-[4.3.0.1^{2,5}]-3-decene, tricyclo[4.3.0.1^{2,5}]-3,8-decene (3,8-dihydrodicyclopentadiene), tricyclo[4.4.0.1^{2,5}]-3-undecene, tetracyclo[4.4.0.1^{2,5},1^{7,10}]-3-dodecene, ethylidenetetracyclo[4.4.0.1^{2,5},1^{7,10}]-3-dodecene, methyloxycarbonyltetracyclo[4.4.0.1^{2,5},1^{7,10}]-3-dodecene, ethylidene-9-ethyltetracyclo[4.4.0.1^{2,5},1^{7,10}]-3-dodecene, pentacyclo[4.7.0.1^{2,5},O,O^{3,13},1^{9,12}]-3-pentadecene, pentacyclo[6.1.1^{3,6},0^{2,7},0^{9,13}]-4-pentadecene, hexacyclo[6.6.1.1^{3,6},1^{10,13},0^{2,7},0^{9,14}]-4-heptadecene, dimethylhexacyclo[6.6.1.1^{3,6},1^{10,13},0^{2,7},0^{9,14}]-4-heptadecene, bis(allyloxycarboxy)tricyclo[4.3.0.1^{2,5}]decane, bis(methacryloyloxy)tricyclo[4.3.0.1^{2,5}]decane, bis(acryloyloxy)tricyclo[4.3.0.1^{2,5}]decane.

The cycloolefinic polymers are prepared using at least one of the above-described cycloolefinic compounds, particularly the polycyclic hydrocarbon compounds. In the preparation of the cycloolefinic polymers it is additionally possible to use further olefins which can be copolymerized with the aforementioned cycloolefinic monomers. These include ethylene, propylene, isoprene, butadiene, methylpentene, styrene and vinyltoluene.

The majority of the abovementioned olefins, including in particular the cycloolefins and polycycloolefins, can be obtained commercially. Furthermore, many cyclic and polycyclic olefins are obtainable by means of Diels-Alder addition reactions.

The cycloolefinic polymers can be prepared conventionally, as set out inter alia in Japanese patents 11818/1972, 43412/1983, 1442/1986 and 19761/1987 and in Japanese laid-open specifications No. 75700/1975, 129434/1980, 127728/1983, 168708/1985, 271308,1986, 221118/1988 and 180976/1990 and in European patent applications EP-A-0 6 610 851, EP-A-0 6 485 893, EP-A-0 6 407 870 and EP-A-0 6 688 801.

The cycloolefinic polymers can be polymerized, for example, using aluminium compounds, vanadium compounds, tungsten compounds or boron compounds as catalyst in a solvent.

It is assumed that the polymerization is able to take place with ring opening or with opening of the double bond depending on the conditions, in particular on the catalyst employed.

A further possibility is to obtain cycloolefinic polymers by free-radical polymerization, using light or an initiator to form free radicals. This applies in particular to the acryloyl derivatives of the cycloolefins and/or cycloalkanes. This kind of polymerization can be carried out both in solution and without solvent.

A further preferred polymeric substrate comprises poly(meth)acrylates. These polymers are generally obtained by free-radical polymerization of mixtures comprising (meth)acrylates. These have been described above; depending on preparation, both monofunctional and polyfunctional (meth)acrylates can be used, which are described under component C) and E).

In accordance with one preferred aspect of the present invention these mixtures contain at least 40% by weight, preferably at least 60% by weight and more preferably at least 80% by weight, based on the weight of the monomers, of methyl methacrylate.

Besides the (meth)acrylates described above the compositions to be polymerized may also include further unsaturated monomers which are copolymerizable with methyl methacrylate and with the aforementioned (meth)acrylates. Examples thereof have been set out in more detail in particular under component E).

Generally speaking these comonomers are used in an amount of from 0 to 60% by weight, preferably from 0 to 40% by weight and more preferably from 0 to 20% by weight, based on the weight of the monomers, it being possible to use the compounds individually or as a mixture.

The polymerization is generally initiated with known free-radical initiators, described in particular under component D). These compounds are frequently used in an amount of from 0.01 to 3% by weight, preferably from 0.05 to 1% by weight, based on the weight of the monomers.

The aforementioned polymers may be used individually or as a mixture. In this case it is also possible to use different polycarbonates, poly(meth)acrylates or cycloolefinic polymers, which differ, for example, in molecular weight or in monomer composition.

The polymeric substrates of the invention can be produced, for example, from moulding compounds of the aforementioned polymers. In this context it is generally the case that thermoplastic shaping processes are employed, such as extrusion or injection moulding.

The weight-average molecular weight, M_{w}, of the homopolymers and/or copolymers for use in accordance with the invention as a moulding compound for producing the polymeric substrates, can vary within wide ranges, the molecular weight normally being harmonized with the intended application and with the processing mode of the moulding compound.

In general, however, it is within the range between 20,000 and 1,000,000 g/mol, preferably from 50,000 to 500,000 g/mol and more preferably from 80,000 to 300,000 g/mol, without thereby making any restriction. This parameter can be determined, for example, by means of gel permeation chromatography.

The polymeric substrates may additionally be produced by cell casting processes. In this case, for example, suitable (meth)acrylic blends are charged to a mould and polymerized. Such (meth)acrylic blends generally comprise the above-described (meth)acrylates, especially methyl methacrylate. The (meth)acrylic blends may further comprise the above-described copolymers and also—especially for adjusting the viscosity—polymers, especially poly(meth)acrylates.

The weight-average molecular weight M_{w} of the polymers produced by cell casting processes is generally higher than the molecular weight of polymers which are used in moulding compounds. This results in a number of known advantages. The weight-average molecular weight of polymers produced by cell casting processes is generally in the range from 500,000 to 10,000,000 g/mol, with no resultant intended restriction.

Preferred polymeric substrates produced by the cell casting process can be obtained from Degussa, BU PLEXIGLAS, Darmstadt under the trade name PLEXIGLAS®GS or from Cyro Inc. USA, commercially, under the trade name ®Acrylite.

In addition, the moulding compounds to be used to produce the polymeric substrates, and also the acrylic resins, may comprise additives of all kinds. These include antistats, antioxidants, mould release agents, flame retardants, lubricants, dyes, flow improvers, fillers, light stabilizers and organophosphorous compounds, such as phosphoric esters, phosphoric diesters and phosphoric monoesters, phosphites, phosphorinanes, phospholanes or phosphonates, pigments, weathering stabilizers and plasticizers. The amount of additives, however, is restricted in relation to end application.

Particularly preferred moulding compounds comprising poly(meth)acrylates are available commercially under the trade name PLEXIGLAS® from Degussa, BU PLEXIGLAS, Darmstadt or under the trade name ®Acrylite from Cyro Inc. USA. Preferred moulding compounds comprising cycloolefinic polymers may be obtained under the trade name ®Topas from Ticona and ®Zeonex from Nippon Zeon. Polycarbonate moulding compounds are available, for example, under the trade name ®Makrolon from Bayer or ®Lexan from General Electric.

With particular preference the polymeric substrate contains at least 80% by weight, in particular at least 90% by weight, based on the total weight of the substrate, of poly(meth)acrylates, polycarbonates and/or cycloolefinic polymers. With particular preference the polymeric substrates are composed of polymethyl methacrylate, it being possible for the polymethyl methacrylate to include customary additives.

In accordance with one preferred embodiment it is possible for polymeric substrates to have an impact strength to ISO 179/1 of at least 10 mJ/m², preferably at least 15 kJ/m².

Neither the shape nor the size of the polymeric substrate is critical to the present invention. In general the substrates used are often in the form of panels or sheets, with a thickness in the range from 1 mm to 200 mm, in particular from 5 to 30 mm.

The mouldings can be vacuum-formed components, blow-moulded components, injection-moulded components or extruded polymeric components, which are used, for example, as construction elements outdoors, as components of automobiles, casing components, constituents of kitchens or sanitary installations.

The coating compositions are particularly suitable for solid planar sheets and sandwich sheets or multi-wall sheets. Customary dimensions, for example, for solid sheets are in the range from 3×500 to 2000×2000 to 6000 mm (thickness×width×length). Sandwich sheets can have a thickness of from about 16 to 32 mm.

Before the polymeric substrates are given a coating they can be activated by appropriate methods in order to enhance the adhesion. For this purpose it is possible, for example, to treat the polymeric substrate by a chemical and/or physical process, the particular process being dependent on the polymeric substrate.

The coating blends described above can be applied to the polymeric substrates by any known method. Such methods include dipping, spraying, knife coating, flow coating and roller coating methods.

The coating composition is preferably applied to polymeric articles such that the thickness of the cured coat is from 1 to 50 μm, preferably from 5 to 30 μm. At coat thicknesses below 1 μm the weathering protection and scratch resistance is in many cases inadequate; at coat thicknesses of more than 50 μm it is possible for cracking to occur under flexural stress.

After the coating film has been applied to the polymeric article, polymerization takes place, and can be performed thermally or by means of UV radiation. Polymerization can advantageously be carried out under an inert atmosphere in order to exclude the polymerization-inhibiting atmospheric oxygen, e.g. under nitrogen blanketing. This, however, is not an indispensable prerequisite.

The polymerization is normally performed at temperatures below the glass transition temperature of the polymeric article. The applied coating composition is preferably cured by UV irradiation. The UV irradiation time necessary for this purpose depends on the temperature and on the chemical composition of the coating material, on the nature and power of the UV source, on its distance from the coating composition, and on whether there is an inert atmosphere. The guideline value may be from several seconds to a few minutes. The corresponding UV source should emit radiation in the range from about 150 to 400 nm, preferably with a maximum between 250 and 280 nm. The irradiated energy should amount to approximately 50-4000 mJ/cm². As a guideline value for the distance of the UV source from the coating film it is possible to specify from about 100 to 200 mm.

The mouldings of the present invention lend themselves outstandingly to thermal forming without damage as a result to their scratchproof dirt-repellent coating. Forming is known to the person skilled in the art. In this operation the moulding is heated and formed by means of an appropriate template. The temperature at which forming takes place depends on the softening temperature of the substrate from which the polymeric article has been produced. The other parameters, such as the forming rate and forming force, are likewise dependent on the polymer, and these parameters are known to the person skilled in the art. Among the forming methods, particular preference is given to bending methods. Such methods are used in particular for the processing of cast transparent sheets. Further details are found in “Acrylglas und Polycarbonat richtig Be- und Verarbeiten” [Correct machining and use of transparent acrylic sheet and polycarbonate] by H. Kaufmann et al., published by Technologie-Transfer-Ring Handwerk NRW, and in VDI [German engineers' association] guideline 2008 sheet 1 and also DIN 8580/9/.

The mouldings of the present invention provided with a scratchproof dirt-repellent coating exhibit high scratch resistance. The increase in haze after a scratch resistance test to DIN 52 347 E (applied force=5.4 N, number of cycles=100) is preferably not more than 10%, more preferably not more than 5% and very preferably not more than 2.5%.

In accordance with one particular aspect of the present invention the moulding is transparent, the transparency TD65/10 to DIN 5033 being at least 70%, preferably at least 75%.

Without any attendant resultant restriction, the moulding preferably has an elasticity modulus to ISO 527-2 of at least 1000 MPa, in particular at least 1500 MPa.

The mouldings of the invention are generally very stable to weathering. Thus the weathering stability to DIN 53387 (Xenotest) is at least 4000 hours.

Without any attendant resultant restriction, the yellowness index to DIN 6167 (D65/10) of preferred mouldings is less than or equal to 8, preferably less than or equal to 5, even after long UV irradiation for more than 5000 hours.

The anti-graffiti effect is obtained by making the surface repellent to water. This is reflected in a large contact angle with alpha-bromonaphthalene, which has a surface tension of 44.4 mN/m. In accordance with one particular aspect of the present invention the contact angle of alpha-bromonaphthalene with the surface of the polymeric article after the scratchproof coating has cured is preferably at least 50°, in particular at least 70° and more preferably at least 75° at 20° C., without any attendant resultant restriction.

The contact angle with water at 20° C., in accordance with one particular embodiment, is preferably at least 80°, in particular at least 90° and with particular preference at least 100°

The contact angle can be determined using a G40 contact angle measuring system from Krüss, Hamburg, the procedure being described in the G40 contact angle measurement system user handbook, 1993. The measurement is made at 20° C.

The mouldings of the present invention can be used, for example, in the construction sector, particularly for producing glasshouses or conservatories, or as sound-proofing walls.

The invention is explained in more detail below by means of inventive and comparative examples, without any intention that the invention should be restricted to these examples.

### INVENTIVE EXAMPLE 1

A coating composition was prepared containing
16.6 parts by weight of pentaerythrityl tetraacrylate,
66.4 parts by weight of 1,6-hexanediol diacrylate,
10 parts by weight of 2-hydroxyethyl methacrylate,
5 parts by weight of PLEX 8770 (prepolymer obtainable from Röhm GmbH & Co. KG, copolymer of methyl methacrylate, butyl methacrylate and pentaerythrityl tetrathioglycolate),
2 parts by weight of Irgacure 184,
1 part by weight of Zonyl TA-N (fluoroacrylate of the composition: 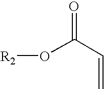
   with R2=CH2CH2(CF2CF2)ₓCF2CF3 where x=2 to 4, available from DuPont and
   3 parts by weight of Tinuvin 1130, available from Ciba AG.

The coating composition obtained in this way is applied to ®Makrolon (available from Bayer AG) sheets using a spiral-wound wire doctor (12 μm wet film thickness) and after two minutes in each case is cured using a high-pressure mercury lamp F 450 from Fusion Systems at a rate of advance of 1 m/min under a nitrogen atmosphere.

The coated sheet is formed by the bending method of DIN 8580/9/over a template at a temperature of 150° C. The bending radius in the experiment was 120 mm. The sheet was subjected to a Taber test to DIN 52347 to determine the scratch resistance and to a cross-cut to DIN 53151. The Taber test was carried out with an applied force of 5.4 N with 100 cycles, using a “CS10F” friction wheel from Teledyne Taber.

The results obtained are set down in Table 1.

TABLE 1

| | | Taber test |
|---|---|---|
| | Cross-cut | (DIN 52347) |
| | (DIN 53151) | Delta-haze |
| Before forming | Gt. 0 | 2.7% |
| After forming (20 minutes at 150° C.) | Gt: 0 | 2.4% |

Surprisingly it is found that the scratch resistance is improved by the forming operation. The elongation at break is 5.9%. In order to determine the dirt repellency effect the coating is sprayed with different paints. After 24 hours the coating of paint is cleaned for about one minute using a pressure washer at 80° C.

It is found that the paints can be removed effectively from the coating. The paints used were yellow Prisma Color Acryl and blue Prisma Color Acryl from SchullerEh′klar GmbH, Austria and also red Pinture Paint Spray, Montana Colors, S.L. Berlin.

### COMPARATIVE EXAMPLE 1

A mixture according to EP 028 614 was prepared which contained 39 parts by weight of pentaerythrityl tetraacrylate, 59 parts by weight of hexanediol diacrylate and 2 parts by weight of Darocur 1116 from Ciba and 1.6 parts by weight of 2-(N-ethylperfluorooctanesulphamido)ethyl acrylate. The mixture was applied to a Makrolon sheet in accordance with Inventive Example 1 using a spiral-wound wire doctor. After a levelling time of two minutes the coating is cured using a high-pressure Hg lamp at a speed of advance of 1 m/min and under a nitrogen atmosphere. As a result of the forming operation, carried out in accordance with Inventive Example 1, fine cracks appeared in the coating. The maximum elongation at break (cracking in the coat) is below 2%.

1. A coating composition for producing formable scratchproof coatings with dirt repellency effect, comprising
A) from 1 to 30% by weight of a prepolymer obtainable by free-radically polymerizing a mixture comprising
A1) from 1 to 10 parts by weight of at least one sulphur compound containing at least 3 thiol groups and
A2) from 90 to 99 parts by weight of alkyl (meth)acrylates,
B) from 0.2 to 10% by weight of fluoroalkyl (meth)acrylate according to the formula (II) 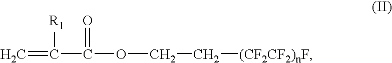
wherein the radical R₁ is a hydrogen atom or a methyl radical and n is an integer in the range from 2 to 10
C) from 20 to 80% by weight of polyfunctional (meth)acrylates,
D) from 0.01 to 10% by weight of at least one initiator,
E) from 2 to 75% by weight of at least one diluent and
F) from 0 to 40% by weight of customary additives.

2. The coating composition according to claim 1, wherein the prepolymer A) has a viscosity number to DIN ISO 1628-6 in the range from 8 to 15 ml/g measured in CHCl₃ at 20° C.

3. The coating composition according to claim 1, wherein the alkyl (meth)acrylates used to prepare the prepolymer A) have 1 to 8 carbon atoms in the alcohol residue.

4. The coating composition according to claim 3, wherein the prepolymer A) is prepared using a mixture of alkyl (meth)acrylates A2) containing at least 10% by weight of methyl (meth)methacrylate and/or ethyl (meth)acrylate and at least 2% by weight of alkyl (meth)acrylates having 3 to 8 carbon atoms.

5. The coating composition according to claim 1, wherein the sulphur compound contains at least four thiol groups.

6. The coating composition according to claim 5, wherein the sulphur compound is pentaerythritol tetrathioglycolate.

7. The coating composition according to claim 1, wherein the coating composition contains from 0.5 to 2% by weight of fluoroalkyl (meth)acrylates in accordance with component B).

8. The coating composition according to claim 1, wherein the initiator in accordance with component D) is a UV initiator.

9. The coating composition according to claim 1, wherein the diluent in accordance with component E) comprises (meth)acrylates having 1 to 10 carbon atoms, styrenes and/or acrylonitrile.

10. The coating composition according to claim 1, wherein component F) comprises UV absorbers and/or UV stabilizers.

11. A scratchproof formable dirt-repellent moulding comprising a polymeric substrate and a scratch-proof coating obtained by a coating composition according to claim 1.

12. The moulding according to claim 11, wherein the polymeric substrate comprises polymethyl methacrylate, polycarbonate, polyvinyl chloride, polystyrene, polyolefins, cycloolefin copolymers, polyesters and/or acrylonitrile/butadiene/styrene copolymers.

13. The moulding according to claim 11, wherein the moulding has an impact strength to ISO 179/1 of at least 10 kJ/m².

14. The moulding according to claim 11, wherein the polymeric substrate has a thickness in the range from 1 mm to 200 mm.

15. The moulding according to claim 11, wherein the scratchproof coating has a coat thickness in the range from 1 to 50 μm.

16. The moulding according to claim 11, wherein the haze of the moulding increases by not more than 5% after a scratch resistance test to DIN 52 347.

17. The moulding according to claim 11, wherein the polymeric substrate has an elasticity modulus to ISO 527-2 of at least 1500 MPa.

18. The moulding according to claim 11, wherein the moulding has a weathering stability to DIN 53 387 of at least 4000 hours.

19. The moulding according to claim 11, wherein the moulding has a transparency to DIN 5033 of at least 70%.

20. The moulding according to claim 11, wherein the contact angle of alpha-bromonaphthalene with the surface of the polymeric article at 20° C. is at least 50°.

21. (canceled)

22. A process for producing a scratchproof formable dirt-repellent moulding comprising applying the coating composition according to claim 1 to a polymeric substrate and curing the coating composition.

23. A scratchproof formable dirt-repellant moulding prepared by the process as claimed in claim 22.
